(19) United States
(12) Patent Application Publication
(10) Pub. No.: US 2025/0019128 A1
(43) Pub. Date: Jan. 16, 2025

(54) SEALING MATERIAL FOR CONTAINER CLOSURES

(71) Applicant: ACTEGA DS GMBH, Bremen (DE)

(72) Inventor: Dany Mängel, Twistringen (DE)

(21) Appl. No.: 18/713,416

(22) PCT Filed: Nov. 30, 2021
(86) PCT No.: PCT/EP2021/083635

§ 371 Date: May 24, 2024

(51) Int. Cl. B65D 41/04; C08L 23/14; C08L 53/00

(52) U.S. Cl. CPC B65D 41/045; C08L 23/14; C08L 53/00; C08L 2205/03

(57) ABSTRACT

A container closure seal, in particular for fat-containing filling materials, comprising a polymer compound of which the seal substantially or entirely consists, wherein the polymer compound is PVC-free and comprises at least one OBC as well as at least one co-PP, but substantially no POE and no homo-PP, and the polymer compound has a Shore A hardness at 70° C. between 30 and 85 and a MFI (5 kg/190° C.) of less than 20 g/10 min, as well as a maximum specific enthalpy of melting, determined in accordance with ISO 11357-3, of 50 J/g.

The invention relates to a PVC-free container closure seal in accordance with the preamble of patent claim 1.

Particular larger container closures of the type considered here are lug caps, which are typically used to close screw-top jars for foodstuffs or beverages. These foodstuffs are often fat-containing products such as convenience food, sauces, delicacies, fish in oil, antipasti, seasoning pastes and the like, the fat or oil content of which increases the risk that fat-soluble components of the packing material could dissolve in the foodstuff.

These requirements are also of particular relevance in the case of infant food, which is typically sold in glass jars with press-on Twist-Off® closures (also referred to here as PT closures or PT caps).

The container closures concerned here usually have an opening width of at least 35 mm, for example 38 mm or more, for example 82 mm and higher. Lug caps here have 4, 5 or more than 5 lugs.

Conventional PVC-based container closures exhibit advantageous sealing properties. Low-migration sealing compounds, which frequently use polyadipates, can also be formulated on the basis of soft PVC technology. They are less prone to migration due to their molecular weight.

The prescribed test method for assessing migration, EN 1186, postulates that migration is complete after storing for 10 days at 40° C. However, analytical practice has shown that this is not the case for plasticized PVC, so that under actual conditions for the storage of glass storage jars, the tolerated overall migration of up to 60 mg per kg of foodstuff or the specific migration limits for plasticizers in primarily oil-containing foodstuffs are significantly exceeded before the minimum “store-until” date.

Furthermore, it is undesirable to use PVC-containing compounds in packaging materials. In the conventional incineration of household waste, halogenated plastics generate acidic gases the escape of which into the atmosphere is harmful. In addition, even small quantities of PVC impede mechanical recycling of plastic waste. Moreover, such PVC-based sealing elements require the use of plasticizers, which are also unsafe for reasons of unacceptable modification of the foodstuff. Furthermore, in recent years, a public debate on plasticizers, additives and their decomposition products in PVC seals has been ongoing. Examples in this regard are 2-ethylhexanoic acid, which is often generated from stabilizers, and semicarbazide, which can be formed from exothermic blowing agents such as azodicarbonamide. These substances were also found in official checks on filling materials and their presence was objected to.

There is therefore a need for PVC-free container closure seals which emulate the favourable properties of known PVC-containing seals as closely as possible.

A problem with polymer-based container closure seals is often the migration of seal components into the filling material. Migration problems occur particularly frequently with fat-containing or oil-containing filling materials, because the migrating materials such as plasticizers and extenders are often fat-soluble.

The migration of components of the packaging (which, if appropriate, also includes the sealing insert of the container closure) into the foodstuff is not only generally undesirable, but also strictly regulated by law. Examples of such regulations are the EC Regulations 1935/2004, 2023/2006, (EU) 10/2011, including the amending Regulations (EU) 321/2011, (EU) 1282/2011, (EU) 1183/2012, (EU) 202/2014, (EU) 174/2015, (EU) 2016/1416, (EU) 2017/752, (EU) 2018/79, (EU) 2018/213, (EU) 2018/831, (EU) 2019/37 and (EU) 2019/1338. Currently, the maximum permissible quantity of migrating components is 60 ppm.

The measurement of the extent of migration which may be observed is carried out using methods as defined in DIN EN 1186 in particular. Such methods are also used in the context of the present invention.

Providing container closures of the type considered here with PVC-free sealing inserts is not a trivial problem if these closures have to follow the regulations set down concerning the possible migration of their chemical components. In addition, the sealing function must be guaranteed under filling conditions,

In accordance with the invention, PVC-free compounds are used. In the product in accordance with the invention, migration can be substantially or completely prevented by dispensing with liquid components and/or by using polymers which are less prone to migration, as well as other measures.

In this regard, the requirements for the sealing materials in container closures for larger internal diameters (of at least 35 mm) for the container opening are more demanding simply because of the relatively larger quantities of material in the seal. For such purposes, it is particularly important to combine a sufficient flowability of the polymer material during the manufacture of the sealing element with sufficient sealing properties in the closed state; this also includes the seal against the penetration of or escape of gases which is required nowadays, if appropriate combined with a pressure relief valve action, which prevents bursting of the container upon heating or the development of excess pressure in the container for other reasons. In addition, however, simply for the typical use of containers with larger opening diameters (for example glass jars), it is a requirement that the sealing element can also be used under pasteurization conditions and, if appropriate, even under sterilization conditions.

A highly relevant problem with container closures with large diameters is also the resistance of the closure to opening (particularly under vacuum). This resistance should be as small as possible, but without compromising the reliability of the seal.

All of these features must also comply with the aforementioned requirements as regards any migration of chemical components.

A recent successful solution to these problems which has been introduced is disclosed in our application EP 09 756 681, now patent number EP 2 470 435. The seal described therein is PVC-free and is based on a combination of at least one olefin block copolymer (OBC) with at least one polyolefin elastomer (POE), high density polyethylene (HDPE) or polypropylene or propylene copolymer ((co)-PP). It does not contain any TPS. The Shore A hardness is between 45 and 95; the compression set is between 30% and 90%.

In order to facilitate the processing of conventional compounds, components which are liquid at the application temperature, such as extenders and/or plasticizers (preferably white oil), are usually added. However, slip additives and compounds which are liquid at 20° C. are essentially dispensed with in known formulations because they could promote migration.

This known product is extremely suitable for many applications, but needs improvement for some applications. Thus, in the case of mechanical closing procedures, the seal could be cut through if the closing pathway is very short and the machine can only be adjusted to a limited extent. On the other hand, in the case of closing machinery which runs very quickly, it may sometimes be the case that the processing time does not allow the closure to heat up sufficiently, which in turn results in an insufficient embedding of the glass opening in the sealing mass and therefore constitutes a risk of a leaky package (loss of vacuum following closing or during post-treatment or during transport and storage of the packaging for sale).

In addition, the surface of the seal may become sticky at appropriate POE contents, which could lead to raised opening values.

It would therefore be desirable to have available a seal which was thermally stable and also softer than the known seals from EP 09 756 681 and which resulted in fewer through cuts. This seal should emulate the advantageous properties of the known seal as far as possible; for example, they should be able to be used under pasteurization conditions and should comply with the migration limits when in contact with fats.

In addition, such seals should have opening torques which are as low as possible so that screw closures such as lug caps, PT closures and other screw closures can be opened easily. It must also be ensured that the closure cannot be opened inadvertently, and so the opening value cannot be too low.

In normal 82 mm Twist Off® closures, the opening torque for PVC-containing seals is often in the range from 4.8-6.2 Nm (42-55 inch·lbs) or higher. For technically complicated Orbit® closures (WO 2010136414 A1), with PVC-based seals, which were developed in order to reduce the torque required for opening, this is less than 4 Nm. In the case of the known seal in accordance with EP 09 756 681, typical opening values for Twist Off® closures are 4.3-5.1 Nm. A lower opening value would also be advantageous with PVC-free closures, in order to facilitate opening of this type of packaging, particularly with older consumers.

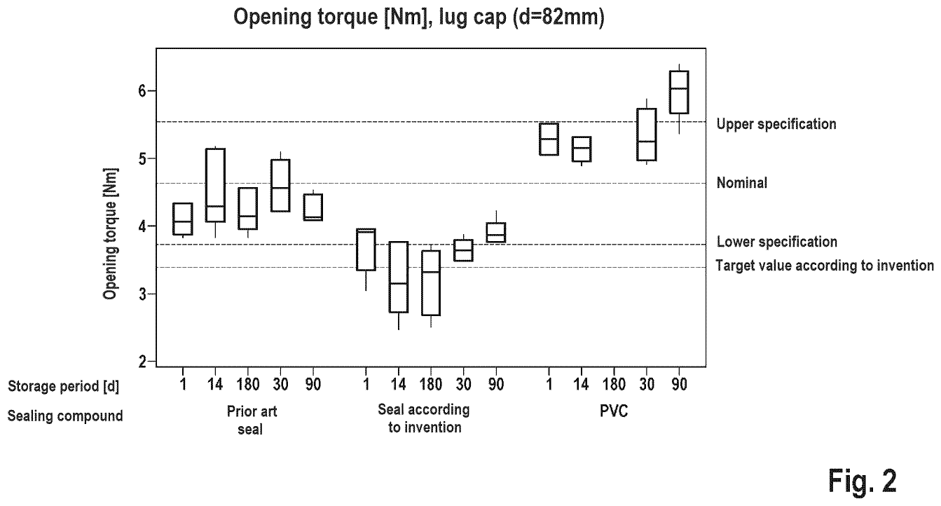

(See FIG. 2).

An essential objective of the invention is to provide such a seal.

In principle, the invention achieves this and other objectives by means of the combination of features defined in the independent patent claims.

As already provided in the solution of EP 09 756 681, the disclosure of which we are incorporating in full into the disclosure of this application by reference, the seal of the invention preferably comprises a polymer compound which is introduced into a closure blank produced from metal or plastic in a thermally sufficiently fluid form and which is brought into the desired form therein, which it retains following cooling, by stamping or the like. In these cases, the finished seal usually consists entirely of the polymer compound. Appropriate manufacturing machines are available from SACMI, for example.

The terms “seal”, “sealing insert” and “sealing element” are synonymous in the context of this description.

In the container closures in accordance with the invention, the sealing element is formed in a similar manner, preferably as a circular disk-shaped insert which is flattened over the inner surface of the container closure, as is also the case with known screw caps.

In principle, in accordance with the manufacturing process in accordance with the invention, the starting point is a container closure blank produced from metal which has a suitable coating system on its inside. In the case of a plastic container closure, this pre-treatment is not necessary.

The coating system usually consists of a base coat and an adhesive coat, which may both be based on an epoxy-phenolic resin system, or in fact on polyesters (usually for regulatory reasons).

Particularly suitable coating systems are those from ACTEGA Rhenania (TPE279 base coat with TPE 1500 adhesive coat or ACTEcoat® TPE 515 with ACTEbond® TPE-655-MF), to which the most preferred compounds in accordance with the invention adhere particularly well.

As an alternative to this, a suitable primer coating may be applied by laying-up, lamination, or even by co-extrusion.

In preferred embodiments, the polymer material which is to form the seal is applied to the inside of the blank which has been pre-treated in this manner in a form which has been made thermally fluid. Extrusion is particularly suitable in this regard, in which the sealing compound is provided in a temperature range between 100° C. and 260° C.

The extrusion may be carried out approximately into the centre of the inner surface of the blank when the sealing insert is to be in the form of a circular disk. The metering of the polymer material for the extrusion occurs by removing a defined quantity of the polymer compound at a nozzle. Subsequently, the sealing element is preferably formed from the extruded, still-fluid material by appropriate stamping (in analogous manner to the known compression moulding process).

Although with known bottle closures (crown corks and the like), the sealing element is usually formed as a circular disk on the inside of the container closure, in the case of larger container closures such as those in accordance with the invention, it may instead be advantageous to form only a ring of polymer material which, when the container is closed, sits on the wall of the container in the region of the opening. The system technology required for this is also commercially available.

In a modified form, the sealing element may be formed outside the closure or closure blank by stamping a suitable polymer material and then be introduced into the closure or blank. This process is known to SACMI as outshell moulding.

The material of the sealing insert comprises a polymer component as the main component or the only component which comprises at least two different polymers, namely at least one OBC and at least one co-PP or comparable polyolefin. The properties of these principally polymeric components may be modified appropriately by blending in other components, for example other polymers.

The invention differs from the concept known from EP 09 756 681, according to which the desired seal or the polymer compound of the seal has to contain a POE. A POE is not obligatorily present and preferably not present at all in the seal in accordance with the invention.

It has surprisingly been shown that POEs in the known seal can in many cases be largely replaced by other polymers.

Dispensing with POEs like this aids in solving a problem which occasionally arises in the known seals: glass containers are usually finish-annealed, for example by coating with PE waxes. When used with such glass containers, seals containing POE may exhibit a deleterious interaction, which increases the opening value for the closure in an undesirable manner.

In preferred embodiments of the invention, the seal does not contain any POEs in an analytically detectable amount. In other preferred embodiments, a small amount of at least one POE may be present, but it is kept so low that the opening value for the seal is not significantly modified compared with an identical seal containing no POE.

In accordance with the invention, the polymer compound additionally comprises at least one polyolefin, in particular a co-PP and/or a relatively soft polyethylene or co-polyethylene, preferably with a hardness of less than Sh D 40.

The degree of crystallinity of the polyolefin is as low as possible; we shall discuss this further below. In the combination with co-PP, the polyolefin can often be replaced by another polymer with similar physical properties.

The polymer compound may optionally contain further polymers. However, in accordance with the invention, the polymer compound does not contain any analytically detectable amount of TPS, for example SEBS or SEEPS. In other preferred embodiments, a low content of at least one TPS may be present, but it is kept so small that the properties of the seal do not change in any relevant manner compared with an identical seal without a TPS content. This in particular addresses the aforementioned migration problem, because TPS fractions can enhance the lipophilic nature of the polymer compound.

In this regard, preferably, the material of the sealing insert has only very low and particularly preferably absolutely no quantities of components which are liquid at the temperature of use. This measure also reduces the migration tendency.

The temperature of use is usually identical to the ambient temperature, i.e. in the region of the usual ambient temperatures in the open air or in heated rooms. Typically, the temperature of use is 20° C.

Preferably, therefore, only small or preferably absolutely no quantities of liquid extenders, such as white oil in particular, are added to the material of the sealing insert.

Preferably, the material contains no more than 10%, preferably no more than 7%, in particular no more than 4% and particularly preferably no more than 1% of slip additives, in particular those which, in a migration test at 40° C. for 10 days, pass into the fat-containing filling material in a restricted manner.

In this application, the percentages given are always percentages by weight with respect to the total weight of the compound in the seal, unless expressly stated otherwise.

It is currently usually preferable for the material to contain substantially no components which are liquid at 20° C. within the analytical limits of determination given at the date of the application and also none of the usual plasticizers.

Polymer compounds in accordance with the invention generally have a Shore A hardness at 70° C. between 30 and 85, especially between 40 and 75, particularly preferably between 45 and 65. The smaller the hardness, the more easily can the closures be applied. When used on steam vacuum sealing machines, there is an increased risk of through-cuts if the hardness is below Shore A 30 at 70° C. Above Shore A 85, the risk that closing will not occur is increased.

A worthwhile method for characterizing the mechanical properties of elastic polymer materials is the anisothermal stress relaxation test (AISR method). According to VENNEMANN (for example in the work “PRAXISGERECHTE PRÜFUNG VON TPE” [“Practical testing of TPE” ]), thermal limits for the use of TPEs can be determined with this method. An essential parameter which is determined from the test is the temperature limit at which 90% of the initial tension introduced by extending an S2 test body at room temperature by 50% has dissipated (T90). The thermal stability of the tested material is greater the higher is the determined limiting temperature T90. The “TSSR Meter” from Brabender Messtechnik is suitable for carrying out the measurement method. This method serves as a replacement for or supplement to the known (and standardized) determination of the compression set and provides data which correlates with the elasticity of the polymer material.

The T90 value shows at what temperature the initial tension introduced by an elongation of 50% has reduced by 90%, i.e. at a specific temperature, the sealing mass or compound only has 10% tension. In accordance with the invention, all of the compounds in accordance with the invention have T90 values of at least 80° C. Using the T90 values, it is possible to read whether, during the closing process with the steam vacuum sealing machine with a low Shore A of less than 40 at 70° C. or TSSR initial forces at 10N and T90 at 80° C., no through cuts occur.

After sealing, during and after the cooling process and often also during storage of the sealed container, crystallization processes occur in the polymer compound in the case of PVC-free compounds. These influence the hardness and elasticity of the seal, and with this the tension between the closure and container generated during cooling following the closing process. The slower the crystallization occurs, the smaller is the tension that builds up which has a negative influence on the opening torque.

The peak crystallization temperature and the overall enthalpy of crystallization with respect to the initial sample weight is determined by DSC (dynamic scanning calorimetry) measurement, from the first cooling curve. The rules in this respect are described in ISO standard 11357 or its sub-sections (in particular ISO 11357-3). The variables are measured using a DSC1 system from Mettler Toledo. For this assessment, the practical temperature range of 10-180° C. is observed.

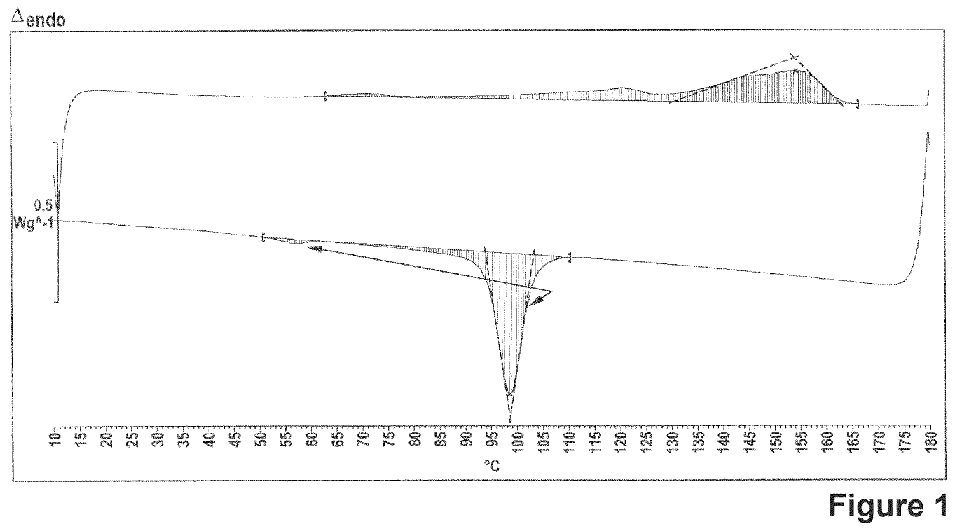

FIG. 1 shows an example of such a DSC curve.

It has been shown to be of assistance for the description of the suitability of a sealing material for vacuum screw closures to formulate polymer compounds in a manner such that the temperature of the exothermic peak is higher than the anticipated maximum temperature of use of the container closure. This exothermal peak temperature from the crystallization process is in part significantly below the temperature of the endothermal melting peak.

In principle, the invention prefers the use of those polymers which have low degrees of crystallinity, while particularly crystalline polymers such as homo-PP, LLDPE, LDPE and HDPE are preferably not used at all, or are only used to a reduced extent.

Preferred polymer compounds have a specific overall enthalpy of crystallization above room temperature of less than 50 J/g, particularly preferably a maximum of 40 J/g, more preferably a maximum of 30 J/g. Overall enthalpies of crystallization of less than 15 J/g can be obtained, particularly when appropriate co-PPs are used.

The OBCs used in accordance with the invention are preferably polyethylene/polyoctene OBCs with a maximum MFI (2.16 kg/190° C.) of 15, preferably a maximum of 2 g/min and highest melting points of less than 130° C. The Shore A hardness is preferably between 50 and 75.

The quantity of the (total) OBC used in the compound is preferably generally 20%-70%, preferably 30% to 65%, particularly preferably 35% to 60%.

The maximum specific enthalpy of melting of the OBC is preferably 30, particularly preferably a maximum of 25 J/g.

Preferred OBCs are available from Dow under the trade name INFUSE®.

Preferred co-PPs have a Shore D hardness of less than 55, preferably below 45, particularly preferably below 40. The Shore D hardness is preferably more than 15, more preferably more than 20, particularly preferably more than 30.

Co-PPs with a MFR (2.16 kg/230° C.) of at least 0.1, more especially at least 0.3 and yet more especially less than 0.5, and a maximum of 15, more especially a maximum of 12 and yet more especially a maximum of 10 g/10 min are especially preferred.

The melting point of the co-PPs is preferably below 165° C., more preferably below 160° C., most preferably below 150° C.

The quantity of co-PP used in the compound is preferably generally 5% by weight-65% by weight. Higher quantities are possible.

The co-PP preferably has a low crystallinity with a relatively high melting point. Preferred co-PPs have an overall enthalpy of crystallization of less than 50 J/g, with melting points above 135° C. or even above 160° C.

Particularly suitable products can be found in LyondellBasell's ADFLEX series range or in Mitsui Chemicals' TAMFER series. VISTAMAXX types from ExxonMobil are also suitable.

In preferred embodiments of the invention, the co-PP may be entirely or partially replaced by other polymers, for example by LLDPE or ethylene-alkylene copolymers such as Stamylex from Borealis, for example, in particular those which have a melting point of more than 100° C.

“Conventional” POEs or POPs can be distinguished from such products, for example Stamylex, by means of their density. Accordingly, a POE only comes into the scope of the invention when the density is below 0.9 g/cm³. Ethylene copolymers, in particular ethylene-octene copolymers, which have a density of 0.9 g/cm³ and more are not POEs in the context of this invention, can therefore be used in formulations within the meaning of the invention.

Such copolymers which may be used in accordance with the invention are also distinguished by melting points above 100° C., determined using DSC in accordance with ISO 11357-3.

The sealing materials in accordance with the invention can withstand a pasteurization of up to 100° C. for up to 60 min, starting from hot filling at at least 60° C. in at most 10 min and at least 1 min. Hot filling, starting from 60° C., may be carried out in steps of 5° up to 100° C. in 60 min.

Optionally, pigments may also be added to the formulations of the compounds. Preferably, inorganic pigments are used in order to eliminate pigment migration. It has also been shown that other additives such as (unsaturated) fatty acid amides, waxes, silicones and other normal additives may be added to the polymer compounds in order, for example, to improve processing and the performance characteristics.

Exemplary embodiments of the invention will now be described by means of the composition of the polymer compounds from which the container closure seal in accordance with the invention as described above was formed:

### Exemplary Embodiment 1

20% co-PP
20% co-PE
57% OBC
3% slip additive/additives
MFI (5 kg/190° C.)=3.1 g/10 min.
Shore A 70° C.=45
Specific enthalpy of melting=30 J/g
T90=95° C.

### Exemplary Embodiment 2

57% co-PP
40% OBC
3% slip additive/additives
MFI (5 kg/190° C.)=1.9 g/10 min.
Shore A 70° C.=54
Specific enthalpy of melting=19 J/g
T90=89° C.

1. A container closure seal, in particular for fat-containing filling materials, the seal consisting essentially of a polymer compound,
a) the polymer compound comprising at least one olefin block compound (“OBC”) as well as at least one propylene copolymer (“co-PP”), but substantially no polyolefin elastomer (“POE”) and no homo-polypropylene (“homo-PP”) and wherein the polymer compound is PVC free,
b) and the polymer compound has a Shore A hardness at 70° C. between 30 and 85 and a MFI (5 kg/190° C.) of less than 20 g/10 min,
c) as well as a maximum specific enthalpy of melting, determined in accordance with ISO 11357-3, of 50 J/g.

2. The container closure seal as claimed in claim 1, in which the polymer compound has a maximum specific enthalpy of melting of 42 J/g.

3. The container closure seal as claimed in claim 1, in which the polymer compound has a Shore A hardness at 70° C. between 30 and 85.

4. The container closure seal as claimed in claim 1, in which the polymer compound comprises a polyethylene/polyoctene-OBC with a maximum MFI (2.16 kg/190° C.) of 15.

5. The container closure seal as claimed in claim 4, in which the fraction of the OBC in the polymer compound is between 20% and 70% with respect to the total weight of the polymer compound.

6. The container closure seal as claimed in claim 4, in which the specific enthalpy of melting of the OBC is a maximum of 30.

7. The container closure seal as claimed in claim 1, in which the polymer compound comprises a co-PP with a MFI (2.16 kg/230° C.) of at least 0.1 g/10 min.

8. The container closure seal as claimed in claim 1, in which the polymer compound comprises a co-PP with a melting point of below 165° C.

9. The container closure seal as claimed in claim 1, in which the polymer compound comprises between 5% and 80% with respect to the total weight of polymer compound.

10. The container closure seal as claimed in claim 1, in which the polymer compound comprises a hydrocarbon-(co)polyolefin, as an additional polymer.

11. The container closure seal as claimed in claim 1, in which the polymer compound contains no more than 10% of slip additives.

12. The container closure seal as claimed in claim 1, in which the polymer compound contains no more than 10% of components which are liquid at 20° C.

13. The container closure seal as claimed in claim 1, which can be pasteurized at 98° C.

14. The container closure seal as claimed in claim 1, which is a vacuum container closure seal.

15. A vacuum container closure with the container closure seal according to claim 14 which can be opened by twisting (standard closure 88 mm, after 4 weeks' storage at 20° C.) with an opening torque of 2.8 to 4.5 Nm.

16. The container closure seal as claimed in claim 3, in which the polymer compound has a Shore A hardness at 70° C. between 40 and 75.

17. The container closure seal as claimed in claim 4 in which the polymer compound comprises a polyethylene/polyoctene-OBC with a maximum MFI (2.16 kg/190° C.) of 2 g/10 min.

18. The container closure seal as claimed in claim 5, in which the fraction of the OBC in the polymer compound is between 35% and 60%.

19. The container closure seal as claimed in claim 6, in which the specific enthalpy of melting of the OBC is a maximum of 25 J/g.

20. A sealed container comprising a container and a closure, the container being sealed with the container closure seal as claimed in claim 1 and including an oil or fat material.
